(19) United States
(12) Patent Application Publication
(10) Pub. No.: US 2013/0339612 A1
(43) Pub. Date: Dec. 19, 2013

(54) APPARATUS AND METHOD FOR TESTING A CACHE MEMORY

(71) Applicant: FUJITSU LIMITED, Kawasaki-shi (JP)

(72) Inventor: Shintarou SUZUKI, Kawasaki (JP)

(73) Assignee: FUJITSU LIMITED, Kawasaki-shi (JP)

(21) Appl. No.: 13/875,060

(22) Filed: May 1, 2013

(30) Foreign Application Priority Data
Jun. 18, 2012 (JP) 2012-137342

(51) Int. Cl. G06F 12/08

(52) U.S. Cl. CPC G06F 12/0851
USPC 711/127

(57) ABSTRACT

An apparatus generates test data for a cache memory that caches data in a cache line in accordance with a memory address. The apparatus generates a memory address to be accessed, data to be arranged in a storage area designated by the memory address, an access instruction for the memory address, and an expected value of the data that is to be cached in the cache memory when memory access is performed in accordance with the access instruction. The apparatus generates an address list including the first memory address, the access instruction, and the expected value, so that the address list is stored in a cache block that is cacheable in the cache memory by one memory access. The apparatus generates test data in which the address list and the data are arranged, so that the address list is cached in a different cache line from the data.

### CROSS-REFERENCE TO RELATED APPLICATION

This application is based upon and claims the benefit of priority of the prior Japanese Patent Application No. 2012-137342, filed on Jun. 18, 2012, the entire contents of which are incorporated herein by reference.

### FIELD

The embodiments discussed herein are related to apparatus and method for testing a cache memory.

### BACKGROUND

A processor that includes a cache memory operable at a higher speed than the main storage unit, such as a memory, and is designed to speed up processing by storing some of the data in a cache memory is known. A cache test for determining whether a cache memory is working normally is carried out on such a processor.

In a cache test, for example, in consideration of the contention of accesses to the same cache line, the configuration of a cache memory, the configuration of a bus, and the like, a memory access is performed so that accesses causing frequent input and output of data occur. Thereafter, a processor assesses the integrity of data by comparing data cached in the cache memory as a result of the memory access with an expected value generated in advance, thereby determining whether or not the cache memory is working normally.

Japanese Laid-open Patent Publication No. 10-55312 discloses related art techniques.

### SUMMARY

According to an aspect of the invention, an apparatus generates test data for a cache memory that caches data in a cache line in accordance with a memory address. The apparatus generates a first memory address to be accessed, data to be arranged in a storage area designated by the first memory address, an access instruction for the memory address, and an expected value of the data that is to be cached in the cache memory when memory access is performed in accordance with the access instruction. The apparatus generates an address list including the memory address, the access instruction, and the expected value, so that the address list is stored in a cache block that is cacheable in the cache memory by one memory access. The apparatus generates test data in which the address list and the first data are arranged so that the address list is cached in a different cache line from the first data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a cache test;

FIG. 2 is a diagram illustrating an example of test data used for a cache test;

FIG. 3 is a diagram illustrating an example of occurrence of an unnecessary contention;

FIG. 4 is a diagram illustrating a configuration example of a test information generating device, according to a first embodiment;

FIG. 5 is a diagram illustrating an example of test data, according to a first embodiment;

FIG. 6 is a diagram illustrating an example of a cache test using test data, according to a first embodiment;

FIG. 7 is a diagram illustrating an example of a cache test of a contention using test data, according to a first embodiment;

FIG. 8 is a diagram illustrating an example of the number of contentions;

FIG. 9 is a diagram illustrating an example of the number of contentions in a cache test using test data generated by a test data generating unit, according to a first embodiment;

FIG. 10 is a diagram illustrating an example of cache test in a plurality of central processing units (CPUs), according to a first embodiment;

FIG. 11 is a diagram illustrating an example of an operational flowchart for a process performed by a test data generating unit, according to a first embodiment;

FIG. 12 is a diagram illustrating an example of an operational flowchart for a cache test, according to a first embodiment;

FIG. 13 is a diagram illustrating an example of an operational flowchart for generating test data, according to a first embodiment;

FIG. 14 is a diagram illustrating an example of an operational flowchart for a cache test, according to a first embodiment; and

FIG. 15 is a diagram illustrating an example of a cache test program, according to a second embodiment.

### DESCRIPTION OF EMBODIMENTS

In recent years, the time taken for a cache test has been increasing with an increase in the capacity of a cache memory included in a processor. It is therefore desirable to increase the efficiency of cache tests.

Hereinafter, a test data generating method, a test method, a test data generating device, and a test data generating program according to the present application will be described with reference to the accompanying drawings.

### First Embodiment

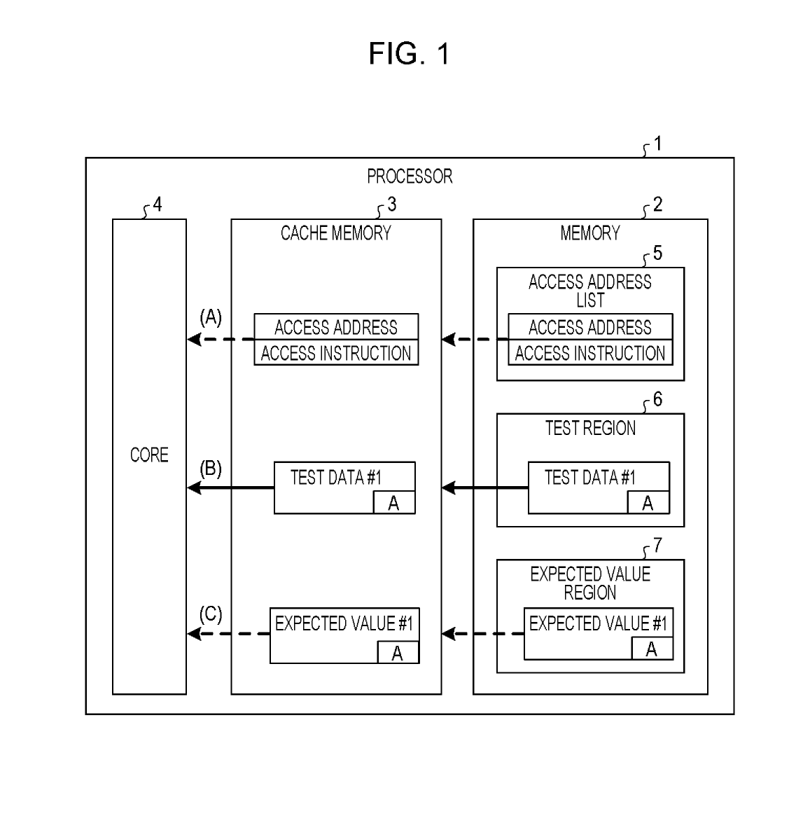

In a first embodiment described hereinafter, an example of a test information generating device for generating test data that allows a cache test to be effectively carried out by executing a test data generating program is described. In order to clarify that an efficient cache test is achieved by using the test data generated by a test information generating device, an example of cash test will be described with reference to FIG. 1 through FIG. 3.

FIG. 1 is a diagram illustrating an example of a cache test. A processor 1 includes a memory 2, a cache memory 3, and a core 4. The memory 2 includes an access address list 5, a test region 6, and an expected value region 7. Here, the cache memory 3 is a direct-mapped cache memory that includes a plurality of cache lines and in which data is cached in cache lines in accordance with memory addresses.

The access address list 5 includes access addresses at which memory access is to be performed by the core 4, and access instructions each indicating whether the content of memory access is reading of data or writing of data. The test region 6 is a region for storing test data #1 containing data “A” to be accessed.

Here, the test data #1 is data having such a size as to be cached in the cache memory 3 in one memory access, that is, data of a cache-block-size, and contains the data “A” in a storage area designated by an access address of the access address list 5. The expected value region 7 is a region for storing an expected value #1 containing the data “A” that is expected to be cached in the cache memory 3 as a result of memory access performed by the core 4.

Hereinafter, an example of cache test that is carried out by the processor 1 will be described. For example, the core 4 accesses the memory 2 and reads the access address list 5. As a result, an access address and an access instruction are cached in the cache memory 3.

Then, as illustrated at (A) in FIG. 1, the core 4 acquires the access address and the access instruction from the cache memory 3 and performs memory access to the acquired access address in accordance with the acquired access instruction. That is, the core 4 performs memory access to the region of the data “A” contained in the test data #1. As a result, the test data #1 containing the data “A” is cached in the cache memory 3.

Then, as illustrated at (B) in FIG. 1, the core 4 reads and writes the data “A” from and to the test data #1 cached in the cache memory 3. Thereafter, the core 4 reads the expected value #1 from the expected value region 7 and causes the expected value #1 to be cached in the cache memory 3. Then, as illustrated at (C) in FIG. 1, the core 4 acquires the data “A” contained in the expected value #1, and compares it with the data “A” contained in the test data #1 in the cache memory 3, thereby testing the cache memory 3 as to whether the cache memory 3 has worked normally.

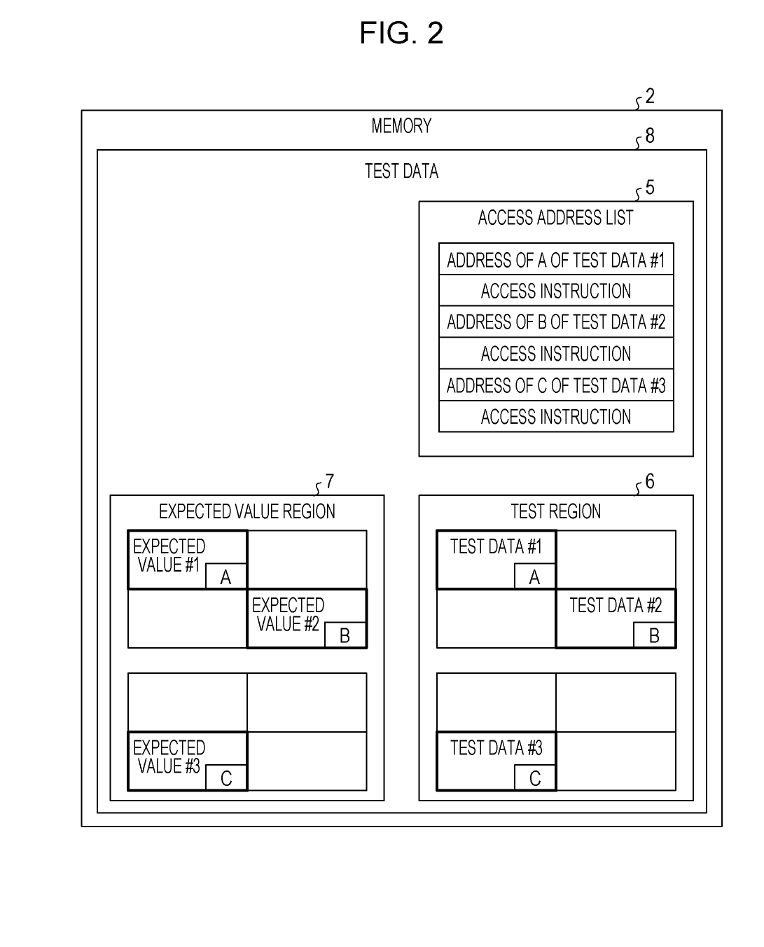

FIG. 2 is a diagram illustrating an example of test data used for a cache test. For example, the test data 8 includes the access address list 5, the test region 6, and the expected value region 7. For example, the access address list 5 includes the memory address and an access instruction of the data “A” contained in the test data #1, and the memory address and an access instruction of the data “B” contained in test data #2. The access address list 5 also includes the memory address and an access instruction of data “C” contained in test data #3.

The test data #1 containing the data “A”, the test data #2 containing the data “B”, and the test data #3 containing the data “C” are stored in the test region 6. The expected value #1 containing the data “A”, an expected value #2 containing the data “B”, and an expected value #3 containing the data “C” are stored in the expected value region 7.

Here, in a cache test, test data is arranged so as to generate a cache mistake that occurs during memory access, replacement, and an arbitration process that occurs because of a contention in a cache. For example, in order to test a contention in the cache memory 3, the test data #1 through the test data #3 of the test region 6 are arranged so as to be cached in the same cache line among cache lines included in the cache memory 3. In particular, when the cache memory 3 caches data in a cache line in accordance with lower bits of a memory address, that is, an index, the data “A”, the data “B”, and the data “C” are arranged at memory addresses having the same index.

In contrast, the expected values #1 through #3 of the expected value region 7 are arranged in such a manner as to facilitate extraction of an expected value and comparison with the entire test region 6. Specifically, the expected value region 7 is arranged in such a manner that its top is aligned with that of the test region 6, and the expected values #1 through #3 are arranged such that offsets from the top of the expected value region 7 to the expected values #1 through #3 are the same as the offsets from the top of the test region 6 to the test data #1 through #3.

By adding a given offset to the memory address of the data “A” of the test data #1, the core 4 is therefore able to readily read the data “A” of the corresponding expected value #1. Likewise, the core 4 is able to readily read the data “B” of the corresponding expected value #2 and the data “C” of the corresponding expected value #3 by adding given offsets to the memory address of the data “B” of the test data #2 and the memory address of the data “C” of the test data #3, respectively.

However, when both the offsets from the top of the test region 6 to the test data #1 through #3 and the offsets from the top of the expected value region 7 to the expected values #1 through #3 are the same, respectively, the test data #1 through #3 and the expected values #1 through #3 will be stored in the same cache line. As a result, when the expected values #1 through #3 are cached, an unnecessary contention occurs and mediation processing occurs, and therefore a cache test will be delayed.

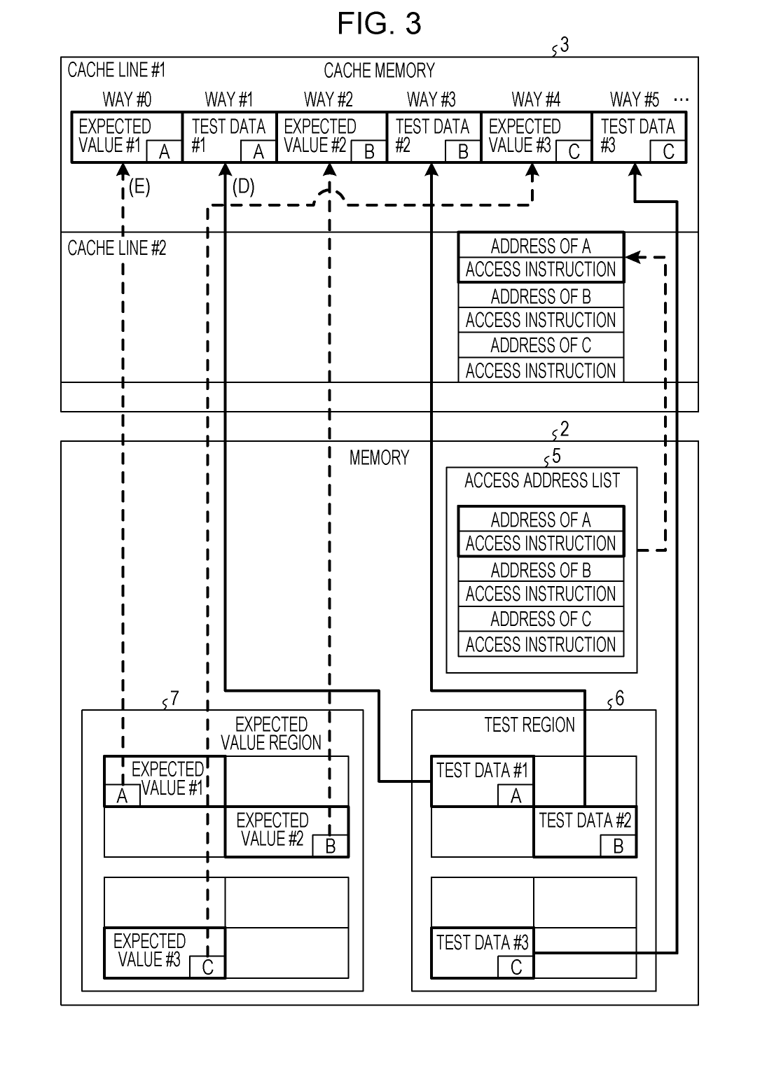

FIG. 3 is a diagram illustrating an example of occurrence of an unnecessary contention. For example, in an example illustrated in FIG. 3, the cache memory 3 includes a cache line #1 and a cache line #2. Here, when the core 4 reads the access address list 5, the cache memory 3 stores the access address list 5 in the cache line #2.

Then, the core 4 performs memory access in accordance with the access address list 5 stored in the cache line #2. For example, the core 4 reads the data “A” of the test data #1. Then, as illustrated at (D) in FIG. 3, the cache memory 3 stores the test data #1 of the test region 6 in the cache line #1.

Next, the core 4 reads the expected value #1 of the expected value region 7 in order to compare the data “A” of the test data #1 cached in the cache line #1 of the cache memory 3 with the data “A” of the expected value #1. Then, in the cache memory 3, as illustrated at (E) in FIG. 3, the expected value #1 is arranged in such a manner that its top is aligned with the top of the test data #1 and has the same offset as the test data #1. For this reason, the expected value #1 will be stored in the cache line #1.

Then, in the cache line #1 of the cache memory 3, since a contention for storing the expected value #1 occurs and mediation processing is performed, the subsequent reading of the test data #2 is delayed. As denoted by dotted lines in FIG. 3, when the core 4 reads the expected value #2, and when the core 4 reads the expected value #3, mediation processing occurs, and therefore the speed of a cache test is reduced.

Moreover, when the expected values #1 through #3 are stored in the same cache line as the test data #1 through #3, there is no available way in this cache line and a time loss caused by a cache mistake sometimes occurs. Thus, a cache test is not efficiently carried out. To address this, a test information generating device described hereinafter generates test data that allows a cache test to be efficiently carried out.

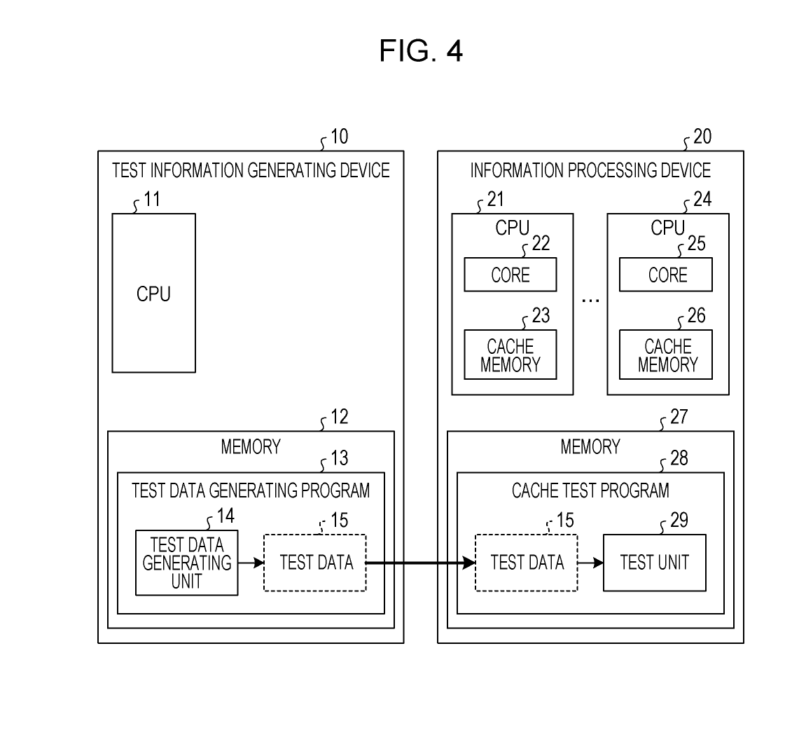

Hereinafter, an example test information generating device for generating test data that allows a cache test to be carried out efficiently will be described with reference to the drawings. FIG. 4 is a diagram illustrating a configuration example of a test information generating device, according to a first embodiment. Note that a test information generating device 10 is a computer including at least a central processing unit (CPU) that executes a test data generating program.

As illustrated in FIG. 4, the test information generating device 10 includes a CPU 11 and a memory 12. The memory 12 stores a test data generating program 13. The test data generating program 13 includes a test data generating unit 14. The CPU 11 executes the test data generating program 13 to cause the test data generating unit 14 to exert its function, thereby generating the test data 15. Thereafter, the test information generating device 10 transmits the test data 15 to an information processing device 20 to be tested.

The information processing device 20 includes a CPU 21, a CPU 24, and a memory 27. The CPU 21 includes a core 22 and a cache memory 23. The CPU 24 includes a core 25 and a cache memory 26. The memory 27 is a shared memory that is shared by the CPU 21 and the CPU 24 and in which a cache test program 28 for testing the cache memory 23 included in the CPU 21 and the cache memory 26 included in the CPU 24 is stored.

The cache test program 28 includes a test unit 29, and the CPU 21 and the CPU 24 execute the cache test program 28 to cause the test unit 29 to exert its function. For example, the test unit 29 receives the test data 15 generated by the test information generating device 10, and has a function of testing the cache memory 23 and the cache memory 26 using the received test data 15.

Note that although not illustrated in FIG. 4, the information processing device 20 may be configured to include a plurality of CPUs that share the memory 27, other than the CPU 21 and the CPU 24. In addition, the CPU 24 exerts the same function as the CPU 21, and the explanation given hereinafter will not be repeated for the CPU 24.

The test data generating unit 14 exerts a function by the test data generating program 13 executed by the CPU 11, and the test unit 29 exerts a function by the cache test program 28 executed by the CPU 21. Such functions will now be described.

The test data generating unit 14 generates data cached by the cache memory 23 under control of the CPU 21, a memory address to be accessed, and an access instruction indicating whether the type of the access is reading of data or writing of data. The test data generating unit 14 generates an expected value of data that is to be cached in the cache memory 23 when the CPU 21 accesses the memory 27 in accordance with an access instruction.

Then, the test data generating unit 14 generates an address list having a memory address, an access instruction, and an expected value gathered together in such a size that the cache memory 23 is able to cache them by one memory access. That is, the test data generating unit 14 generates an address list having a memory address, an access instruction, and an expected value in a size of one cache block.

The test data generating unit 14 then generates the test data 15 that is arranged such that the address list and the data are stored in different cache lines among a plurality of cache lines included in the cache memory 23. For example, the test data generating unit 14 generates the test data 15 in which an address list and data are arranged at different indexes when the test data 15 is stored in the memory 27. Thereafter, the test data generating unit 14 transmits the generated test data 15 to the information processing device 20.

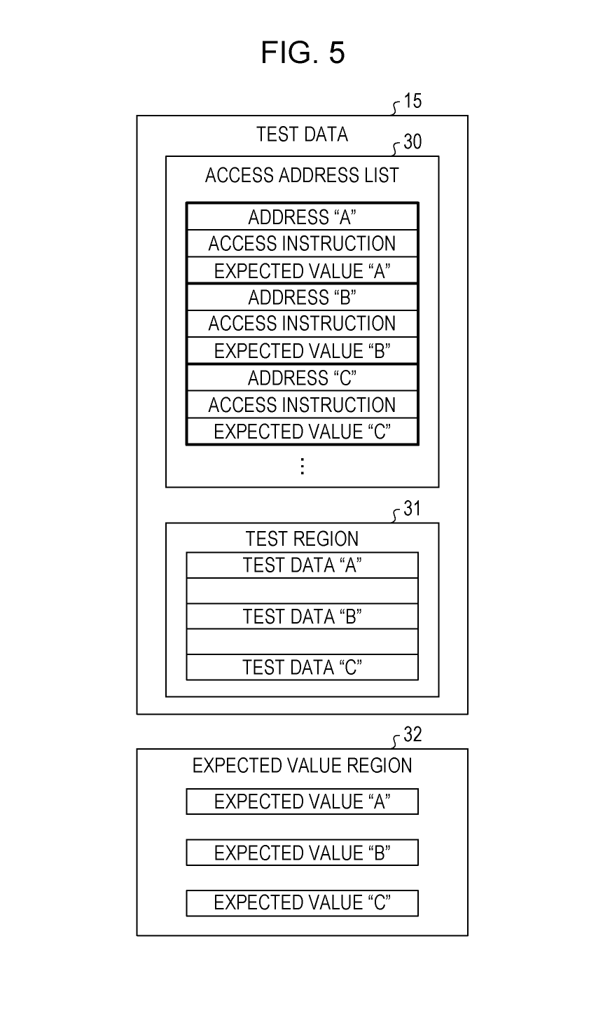

With reference to FIG. 5, an example of the test data 15 generated by the test data generating unit 14 will be described next. FIG. 5 is a diagram illustrating an example of test data, according to a first embodiment. Note that, in FIG. 5, together with the access address list 30 and the test region 31 included in the test data 15, the expected value region 32 used for generation of the test data 15 is illustrated.

First, the test data generating unit 14 generates an address list having a memory address “A” and an access instruction in one cache block and an address list having a memory address “B” and an access instruction in one cache block. The test data generating unit 14 also generates an address list having a memory address “C” and an access instruction in one cache block. Then, the test data generating unit 14 generates the access address list 30 in which address lists are gathered together.

Here, the test data generating unit 14 sets addresses such that test data “A” through test data “C” are stored in the same cache line of the cache memory 23 in order to examine operations during occurrence of a contention in the cache memory 23. For example, the test data generating unit 14 sets the memory address “A” through the memory address “C” whose indexes are the same, among memory addresses of the memory 27.

The test data generating unit 14 then arranges the test data “A” through the test data “C” in the test region 31. Here, the test data generating unit 14 arranges the test data “A” through the test data “C” such that they are stored in storage areas designated by the memory address “A” through the memory address “C” among storage areas of the memory 27. For example, in the case where, in the memory 27, when the test data 15 is stored at the same memory address as in the memory 12, the test data generating unit 14 stores the test data “A” through the test data “C” in storage areas designated by the memory address “A” through the memory address “C”, respectively.

In addition, for example, the test data generating unit 14 may store the test data “A” through the test data “C” in an arbitrary region for storage and may provide an instruction for storage of the test data in storage areas designated by the memory address “A” through the memory address “C” at the time of transmitting the test data 15 to the cache test program 28. Note that the test data generating unit 14 may use arbitrary data as each of the test data “A” through the test data “C”. For example, the test data generating unit 14 may use random data or data of a pattern that is effective for a test of the cache memory 23 as each of the test data “A” through the test data “C”.

Then, the test data generating unit 14 sets a range obtained by adding a given offset to each memory address of each address list included in the access address list 30, as the expected value region 32. The test data generating unit 14 then stores in the expected value region 32 an expected value “A” through an expected value “C” of data that is expected to be stored in the cache memory 23 as a result of reading or writing of the test data “A” through the test data “C”.

Thereafter, the test data generating unit 14 performs processing described below for each address list of the access address list 30. First, when the access instruction included in an address list is “fetch” indicating reading of data, the test data generating unit 14 calculates a memory address obtained by adding a given offset to a memory address included in the address list. Then, the test data generating unit 14 acquires data stored in a storage area designated by the calculated memory address, that is, an expected value, and stores the acquired expected value in the address list.

In contrast, when the access instruction is “store” indicating reading of data, the test data generating unit 14 rewrites the data of the storage area designated by the memory address obtained by adding a given offset to the memory address included in the address list, that is, an expected value, in accordance with the access instruction. The test data generating unit 14 then stores the rewritten expected value in the address list.

For example, regarding the address list including the memory address “A”, the test data generating unit 14 stores the expected value “A” in the storage area designated by a memory address obtained by adding a given offset to the memory address “A”, that is, the expected value region 32. Then, when the access instruction included in the address list is “fetch”, the test data generating unit 14 stores the expected value “A” of the expected value region 32 in the address list including the memory address “A”. In contrast, when the access instruction included in the address list is “store”, the test data generating unit 14 rewrites the expected value “A” of the expected value region 32 in accordance with the access instruction, and stores the rewritten expected value “A” in the address list including the memory address “A”.

As a result, in the example illustrated in FIG. 5, the test data generating unit 14 gathers together the access address “A”, which is a memory address for storage of the test data “A”, the access instruction for the access address “A”, and the generated expected value “A” in one cache block. The test data generating unit 14 also gathers together the access address “B”, which is a memory address for storage of the test data “B”, the access instruction for the access address “B”, and the generated expected value “B” in one cache block.

The test data generating unit 14 also gathers together the access address “C”, which is a memory address for storage of the test data “C”, the access instruction for the access address “C”, and the generated expected value “C” in one cache block. Then, the test data generating unit 14 generates the access address list 30 that is arranged such that cache blocks in each of which an access address, an access instruction, and an expected value are gathered together, that is, address lists, are stored at successive memory addresses.

In contrast, with reference back to FIG. 4, when the cache test program 28 receives the test data 15, the test unit 29 carries out testing of the cache memory 23 using the test data 15. For example, when arranging address lists and data included in the test data 15 in the memory 27, the test unit 29 stores the address lists and data in storage areas designated by memory addresses of different indexes.

The test unit 29 then causes the core 22 to read the address lists and data and load them into the cache memory 23. Thereafter, the test unit 29 causes the core 22 to compare data in the cache memory 23 with expected values included in the address lists, thereby testing the cache memory 23 as to whether the cache memory 23 works normally.

Note that the test unit 29 may arrange the address lists and data using an arbitrary approach. For example, at the time of generating the test data 15 in the memory 12, when the test data generating unit 14 generates the test data 15 in the same arrangement as in the case of arranging the test data 15 in the memory 27, the test unit 29 performs the following processing. That is, the test unit 29 stores the test data 15 in a storage area designated by the same memory address as that at which the test data 15 is stored in the memory 12, among storage areas of the memory 27.

For example, the test data generating unit 14 may specify a location at which the test data 15 is to be arranged in the memory 27 as a memory address, and the test unit 29 may arrange the test data 15 in accordance with the memory address specified by the test data generating unit 14. In addition, the test unit 29 may store data in the memory addresses included in the address list.

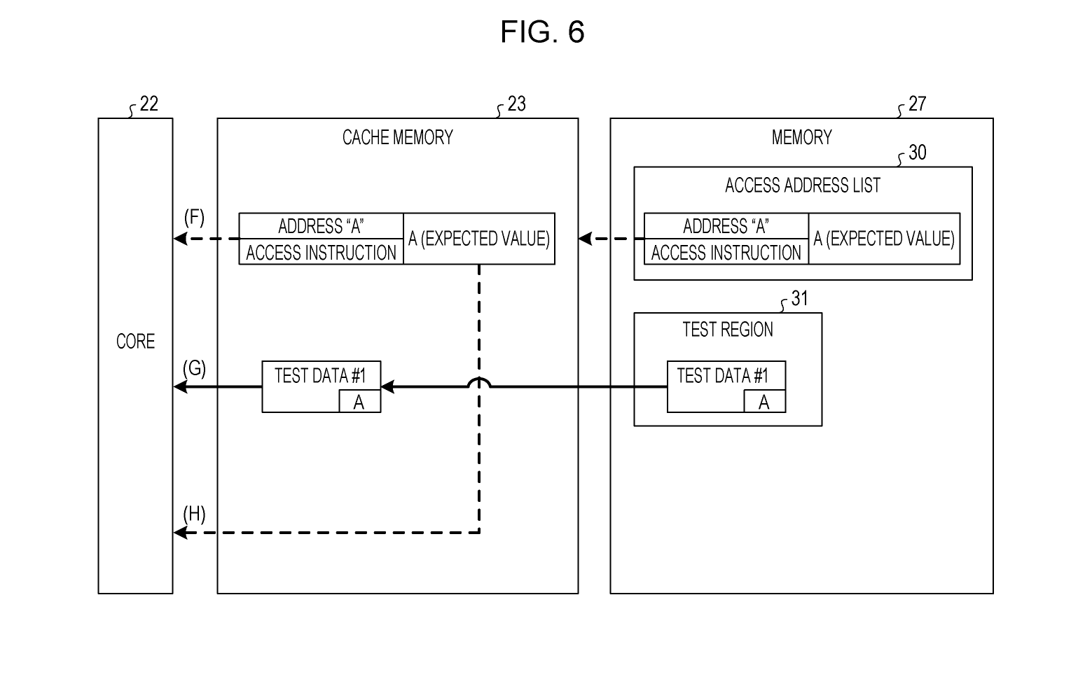

With reference to FIG. 6, processing in which the test unit 29 carries out testing of the cache memory 23 using the test data 15 generated by the test data generating unit 14 will be described next. FIG. 6 is a diagram illustrating an example of a cache test using test data, according to a first embodiment. For example, the test unit 29, when executed by the core 22, causes the core 22 to perform processing described below.

For example, the core 22 reads the access address list 30. Then, by one memory access, the cache memory 23 caches an address list in which the address “A”, an access instruction, and the expected value “A” are gathered together. Then, as illustrated at (F) in FIG. 6, the core 22 acquires the address “A” and the access instruction cached by the cache memory 23.

Then, when the access instruction indicates reading, that is, when the access instruction is “fetch”, the core 22 reads data stored at the address “A”, that is, the data “A” in the test region 31 so that the cache memory 23 caches a cache block including the data “A”, that is, the test data #1.

Then, as illustrated at (G) in FIG. 6, the core 22 acquires the data “A” cached by the cache memory 23. The core 22 then acquires the expected value “A” as illustrated at (H) in FIG. 6.

Here, since the expected value “A” as included in the address list is cached in the cache memory 23, the core 22 is able to quickly acquire the expected value “A”. Thereafter, the core 22 compares the acquired expected value “A” with the data “A” in the cache memory 23, thereby testing the cache memory 23 as to whether the cache memory 23 has worked normally.

In contrast, when the access instruction indicates writing, that is, the access instruction is “store”, the core 22 acquires the expected value “A” cached by the cache memory 23. The core 22 reads the address “A” and causes the cache memory 23 to cache the test data #1.

Then, the core 22 replaces the data “A” contained in the test data #1 in the cache memory 23 with the expected value “A” by writing the acquired expected value “A” at the address “A”. Thereafter, the core 22 compares the expected value “A” with the data “A” in the cache memory 23, thereby testing the cache memory 23 as to whether the cache memory 23 has worked normally.

In this way, the test data generating program 13 generates an address list having a memory address for a test target, an access instruction, and an expected value in one cache block. As a result, the core 22 carries out testing of the cache memory 23 using the expected value already cached in the cache memory 23, without performing memory access for caching the expected value.

Here, the core 22 is able to perform access to the data cached in the cache memory 23 faster than access to the data in the memory 27. As a result, the core 22 may carry out a cache test of the cache memory 23 efficiently.

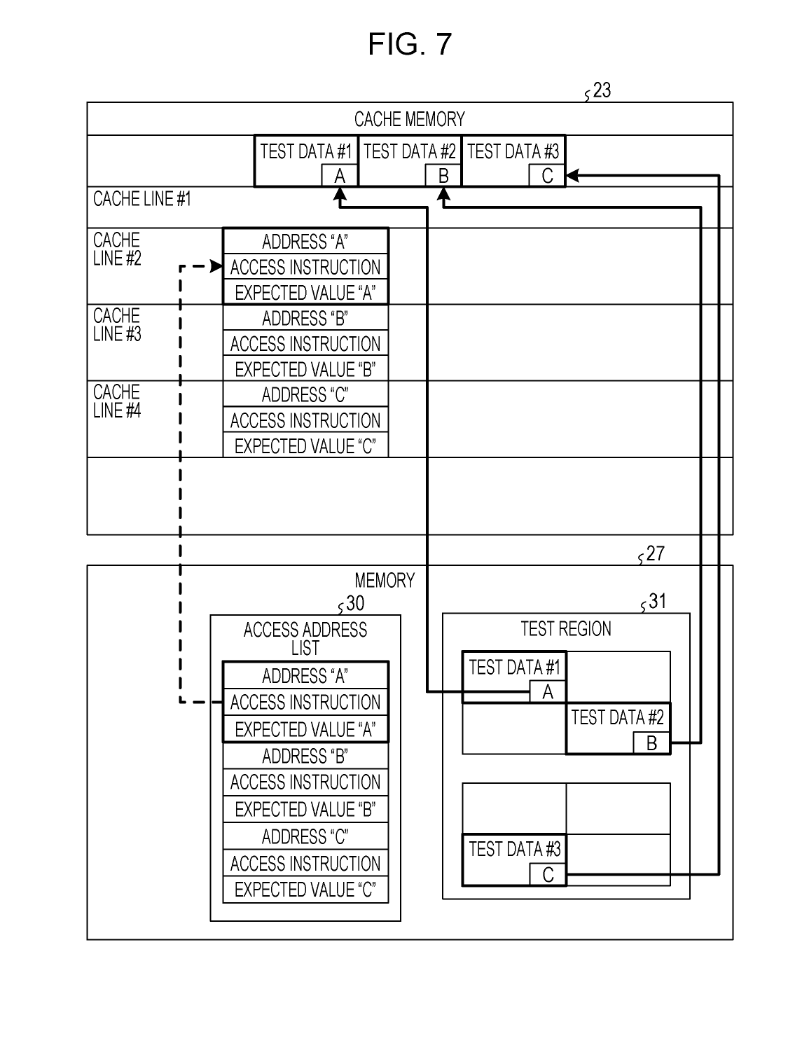

With reference to FIG. 7, processing in which the test unit 29 carries out a cache test of a contention using the test data 15 generated by the test data generating unit 14 will be described next. FIG. 7 is a diagram illustrating an example of a cache test of a contention using test data, according to a first embodiment. Note that, in the example illustrated in FIG. 7, it is assumed that the cache memory 23 has cache lines #1 through #4.

For example, the access address list 30 and the test region 31 included in the test data 15 generated by the test data generating unit 14 are stored in the memory 27. Here, a plurality of address lists in each of which a memory address, an access instruction, and an expected value are contained in one cache block are included in the access address list 30. The address lists are arranged so as to be stored in respectively different cache lines. For example, the address lists are arranged at memory addresses of respectively different indexes.

Therefore, in the case, the cache memory 23 caches an address list including the address “A”, an access instruction, and the expected value “A”, in the cache line #2. The cache memory 23 also caches an address list including the address “B”, an access instruction, and the expected value “B”, in the cache line #3. The cache memory 23 also caches an address list including the address “C”, an access instruction, and the expected value “C”, in the cache line #4. The cache memory 23 may therefore cache each address list included in the access address list 30 without occurrence of a contention.

The memory 27 stores the test data #1 containing the data “A”, the test data #2 containing the data “B”, and the test data #3 containing the data “C” at memory addresses each having the same index. The cache memory 23 therefore stores the test data #1 through the test data #3 in the same cache line #1, and performs mediation processing due to a contention. For example, the cache memory 23 performs deletion of registered data, and registration of data.

The cache memory 23 stores the test data #1 through #3 and the cache blocks of the access address list 30 in the respectively different cache lines #1 through #4. For this reason, a contention does not occur between each of the test data #1 through the data #3 and each of the expected values “A” through “C”.

For example, the cache memory 23 caches, from the access address list 30, the address list including the address “A”, the access instruction, and the expected value “A”, in the cache line #2 by one memory access. The cache memory 23 then caches the test data #1 containing the data “A” in the storing region designated by the address “A”. Here, since the cache memory 23 caches the test data #1 in the cache line #1, which is different from that of the address list including the expected value “A”, a contention does not occur. This enables the cache memory 23 to fast cache the test data #1.

Then, the cache memory 23 caches, from the access address list 30, the address list including the address “B”, the access instruction, and the expected value “B”, in the cache line #3 by one memory access. At this point, the cache memory 23 stores the address list including the address “B”, the access instruction, and the expected value “B” in a different cache line from the address list including the address “A”, the access instruction, and the expected value “A”. This enables the cache memory 23 to fast cache the address list including the address “B”, the access instruction, and the expected value “B”.

In contrast, the cache memory 23 stores the test data #2 containing the data “B” in the storing region designated by the address “B”, in the same cache line #1 as the test data #1. Then, a contention occurs in the cache line #1, and therefore the cache memory 23 performs intended mediation processing. Thereafter, the cache memory 23 stores the address list including the address “C”, the access instruction, and the expected value “C”, in the cache line #4, and stores the test data #3 containing the data “C” in the cache line #1.

Accordingly, the cache memory 23 only performs intended mediation processing at the time of caching of the test data #1 through the test data #3 and does not perform unnecessary mediation processing at the time of caching of the access address list 30. As a result, the CPU 21 may carry out a cache test of the cache memory 23 efficiently.

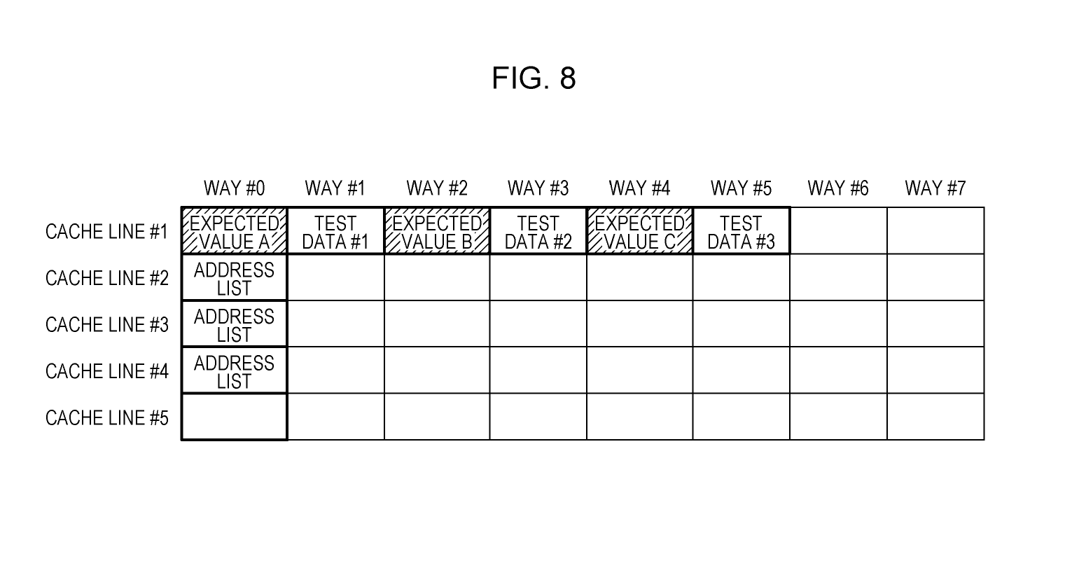

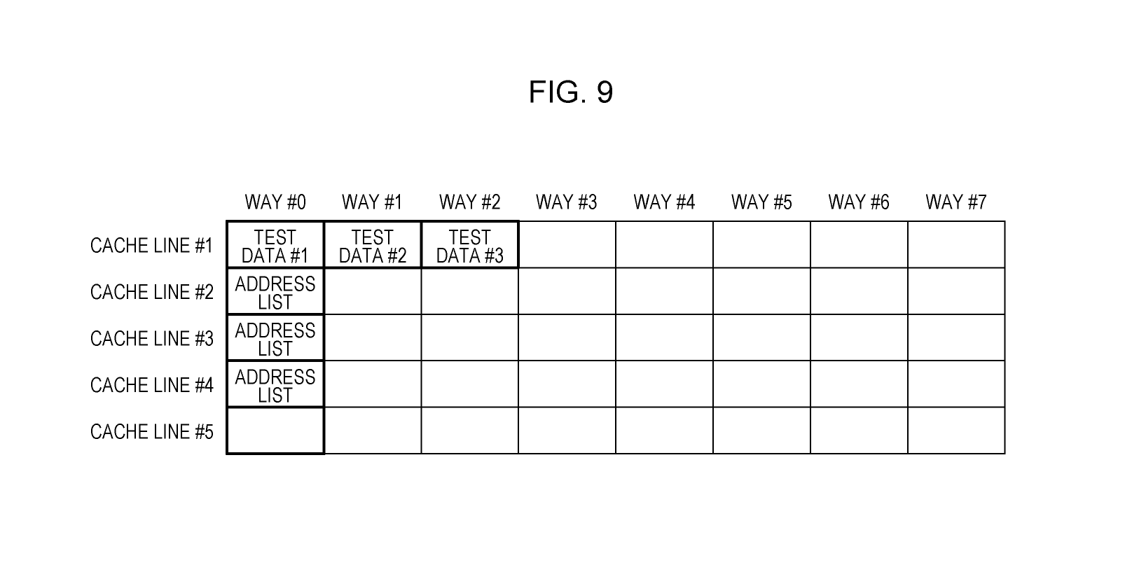

With reference to FIG. 8 and FIG. 9, the numbers of contentions that occur with an approach of the cache test illustrated in FIG. 1 and with the cache test method using the test data 15 generated by the test data generating unit 14 will be described next. First, with reference to FIG. 8, the number of contentions that occur in the cache memory 3 when the cache test method illustrated in FIG. 1 is performed will be described.

FIG. 8 is a diagram illustrating an example of the number of contentions. For example, in the example illustrated in FIG. 8, the cache memory 3 caches the test data #1 through the test data #3 and the expected values A through C that are arranged such that their offsets from their tops aligned with each other are the same. For this reason, the cache memory 3 stores the expected values A through C and the test data #1 through #3 in way #0 through way #5 of the cache line #1. Accordingly, in the cache memory 3, in addition to the case of caching the test data #1 through test data #3, three contentions occur at the time of caching of the expected values A through C.

In contrast, FIG. 9 is a diagram illustrating an example of the number of contentions in a cache test using test data generated by a test data generating unit, according to a first embodiment. For example, in the example illustrated in FIG. 9, the cache memory 23 stores the test data #1 through the test data #3 in the way #0 through the way #2 of the cache line #1. The cache memory 23 also stores address lists of the access address list 30, that is, address lists including the expected values “A” through “C” in the way #0 of the cache lines #2 through #4, respectively.

Therefore, the cache memory 23 only allows two intended contentions to occur at the time of caching of the test data #1 through the test data #3, and does not allow an unnecessary contention at the time of caching of the expected values “A” to “C”. Thus, the test data generating unit 14 enables a cache test of the cache memory 23 to be carried out efficiently by generating the test data 15.

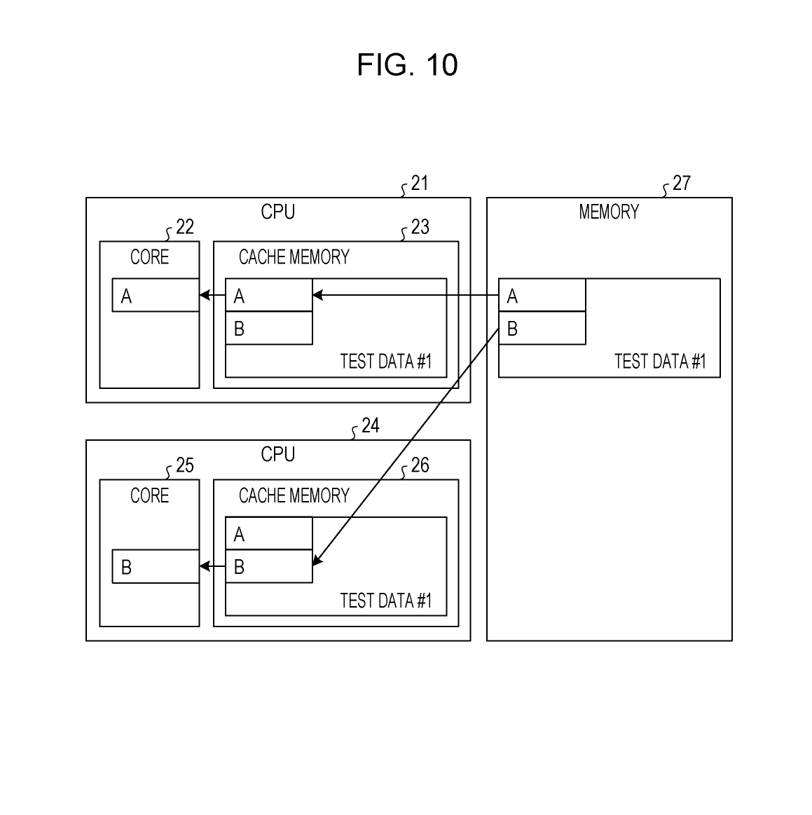

With reference to FIG. 10, an example in which a plurality of CPUs included in the information processing device 20 carry out a cache test by accessing the same cache block in the test data 15 stored in the memory 27 will be described next. FIG. 10 is a diagram illustrating an example of cache test in a plurality of CPUs, according to a first embodiment.

Note that, in FIG. 10, an example where the information processing device 20 includes the CPU 21 and the CPU 24 is illustrated. For example, in the memory 27, the data “A” and the data “B” are stored in the test data #1. The CPU 21 reads the data “A”, thereby causing the cache memory 23 to cache the test data #1.

The CPU 24 reads the data “B”, thereby causing the cache memory 26 to cache the test data #1. That is, the CPU 21 and the CPU 24 access different pieces of data that exist in the same cache block. Then, the CPU 21 and the CPU 24 verify the integrity between the test data #1 cached in the cache memory 23 and the test data #1 in the cache memory 26.

Here, when the CPUs 21 and 24 access the same cache block, whether data is copied in the cache memories 23 and 26 or exclusively used depends on the types of accesses and the protocols for maintaining the coherency. However, coherency of data to be cached has to be ensured in accesses from the CPUs 21 and 24. For this reason, the CPUs 21 and 24 compare the data cached by the cache memory 23 with the data cached by the cache memory 26, which are from the same cache block, thereby testing the cache memories 23 and 26 as to whether the cache memories 23 and 26 maintain coherency.

In such a cache test, when a contention occurs each time the CPU 21 and the CPU 24 read an expected value, the time taken for the cache test would be long. Use of the test data 15 created by the test data generating unit 14, however, allows the CPU 21 and the CPU 24 to carry out a cache test without causing a contention in reading of an expected value. As a result, the test data generating unit 14 enables a cache test to be carried out efficiently.

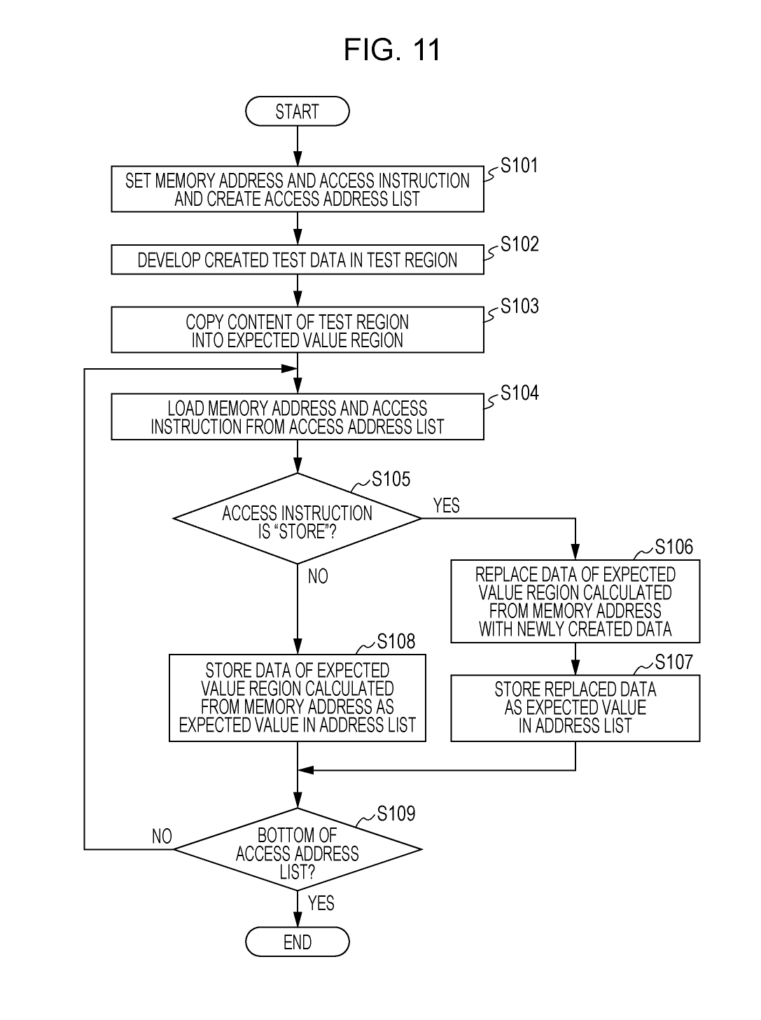

With reference to FIG. 11, the flow of a process in which the test data generating unit 14 generates the test data 15 will be described next. FIG. 11 is a diagram illustrating an example of an operational flowchart for a process performed by a test data generating unit, according to a first embodiment. First, the test data generating unit 14 sets address lists in each of which a memory address to be accessed and an access instruction are stored in one cache block, and creates the access address list 30 including a plurality of the set address lists (step S101). Note that, at this point, an expected value is not stored in each address list of the access address list 30.

Then, the test data generating unit 14 arranges the created test data in the test region 31 (step S102). The test data generating unit 14 then copies the content of the test region 31 into a predetermined expected value region (step S103). Here, the test data generating unit 14 determines a storage area determined from each memory address included in each address list of the access address list 30, as a given expected value region. For example, the test data generating unit 14 determines a storage area designated by a memory address obtained by adding a given offset to each memory address set in each address list of the access address list 30, as the expected value region corresponding to the address list.

The test data generating unit 14 then performs processing described below sequentially from an address list arranged at the top of the access address list 30. The test data generating unit 14 loads the memory address and access instruction set in the address list (step S104). The test data generating unit 14 then determines whether the access instruction is “store” (step S105). When it is determined that the access instruction is “store” (Yes in step S105), the processing described below is performed.

First, the test data generating unit 14 replaces the data of the expected value region determined from the memory address with data to be stored (step S106). Then, the test data generating unit 14 stores the replaced data, as an expected value, in the address list (step S107). When it is determined that the access instruction is not “store” (No in step S105), the test data generating unit 14 stores the data of the expected value region determined from the memory address, as an expected value, in the address list (step S108).

Thereafter, the test data generating unit 14 determines whether the address list in which the expected value is stored is at the bottom of the access address list 30 (step S109). When the address list in which the expected value is stored is not at the bottom of the access address list 30 (No in step S109), the test data generating unit 14 then performs processing of step S104 for the subsequent address list.

When the address list in which the expected value is stored is at the bottom of the access address list 30 (Yes in step S109), the test data generating unit 14 ends the flow of the process of generating the test data 15.

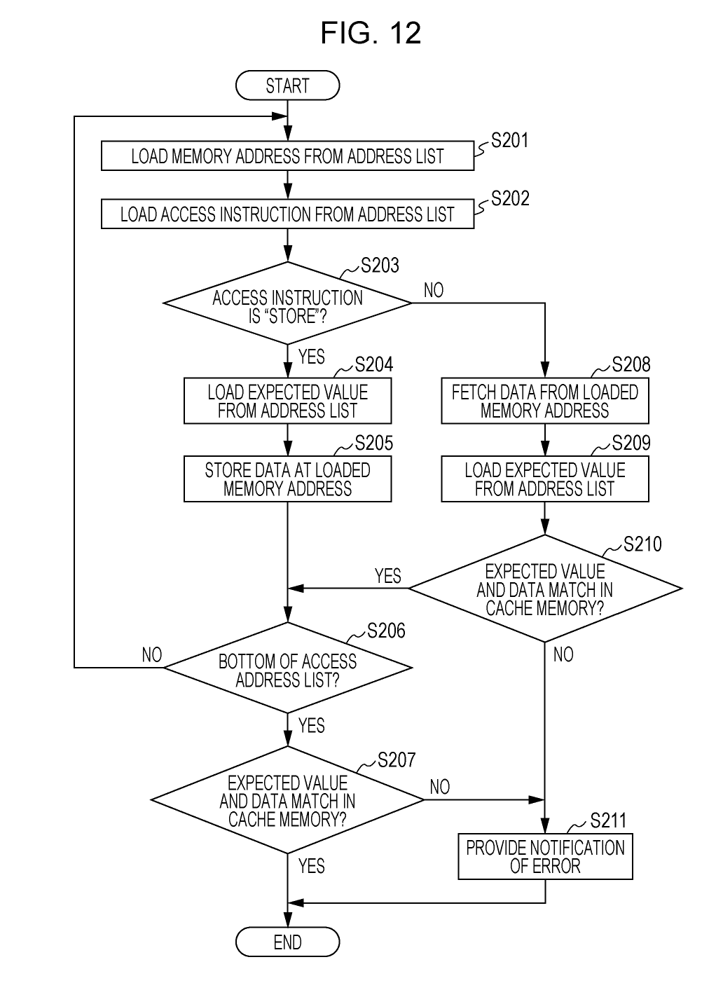

With reference to FIG. 12, the flow of a cache test carried out by the CPU 21 that has executed the cache test program 28 will be described next. FIG. 12 is a diagram illustrating an example of an operational flowchart for a cache test, according to a first embodiment. Note that the CPU 21 performs a process described below for each address list of the test data 15.

First, the CPU 21 loads a memory address from an address list of the access address lists 30 (step S201). At the same time, since a memory address, an access instruction, and an expected value are included in the same cache block, the CPU 21 caches the memory address, the access instruction, and the expected value concurrently in the cache memory 23.

Then, the CPU 21 loads the cached access instruction (step S202). The CPU 21 then determines whether the access instruction is “store” (step S203). When the access instruction is “store” (Yes in step S203), the CPU 21 loads the cached expected value (step S204). The CPU 21 writes the expected value loaded in step S204 at the memory address loaded in step S201 (step S205).

Thereafter, the CPU 21 determines whether the cached address list is at the bottom of the access address list 30 (step S206). When the cached address list is not at the bottom (No in step S206), the CPU 21 performs processing of step S201 for the subsequent address list. When the cached address list is at the bottom of the access address list 30 (Yes in step S206), the CPU 21 determines whether the expected value and data match in the cache memory (step S207). For example, the CPU 21 determines whether the expected value included in the address list cached in step S201 and the data cached in the cache memory 23 at the time of data writing in step S205 match.

When the expected value and the data match in the cache memory 23 (Yes in step S207), the CPU 21 then ends the process. When the expected value 23 and the data do not match in the cache memory (No in step S207), the CPU 21 notifies a user of an error (step S211) and ends the process.

Meanwhile, when the access instruction is not “store” (No in step S203), the CPU 21 fetches data from the memory address of the memory 27 loaded in step S201 (step S208). Then, the CPU 21 loads an expected value from the address list cached in step S201 (step S209). Then, the CPU 21 determines whether the data fetched in step S208 and the expected value loaded in step S209 match (step S210).

Thereafter, when the data fetched in step S208 and the expected value loaded in step S209 match (Yes in step S210), the CPU 21 performs processing of step S206. When the data fetched in step S208 and the expected value loaded in step S209 do not match (No in step S210), the CPU 21 performs processing of step S211.

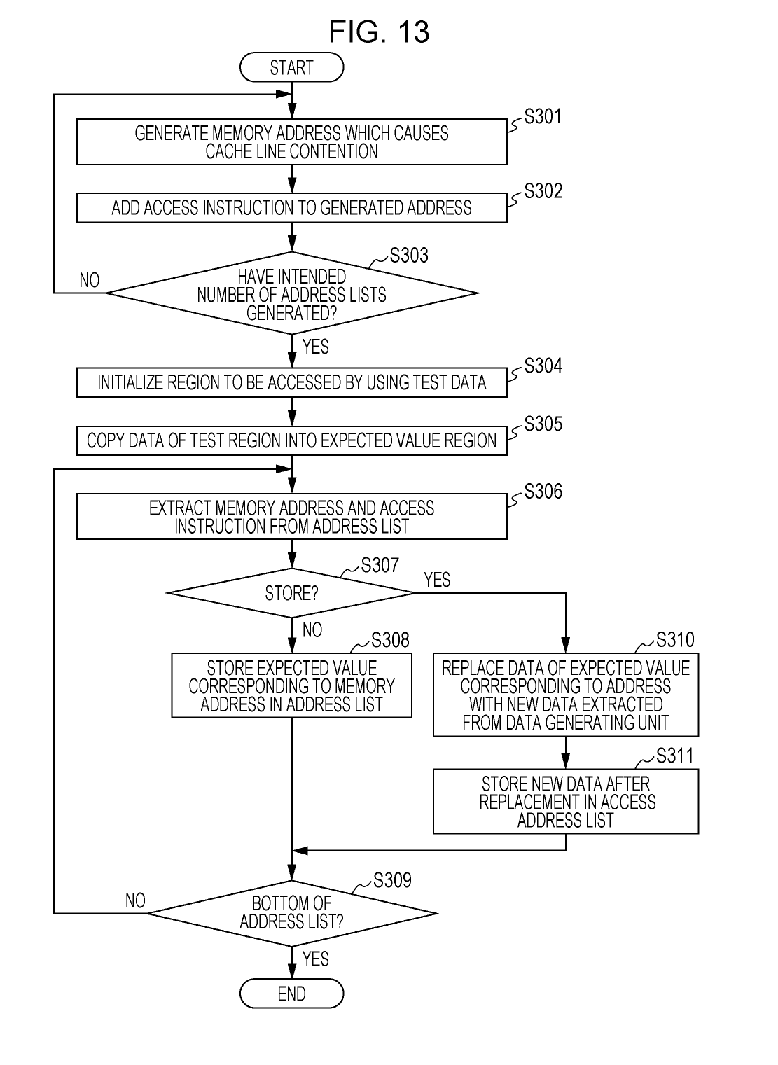

With reference to FIG. 13, an example of a process in which the test data generating unit 14 generates the test data 15 will be described next. FIG. 13 is a diagram illustrating an example of an operational flowchart for generating test data, according to a first embodiment. For example, the test data generating unit 14 generates a memory address that causes a contention in a cache line (step S301).

The test data generating unit 14 then adds “store” or “fetch” as an access instruction to the generated address (step S302). The test data generating unit 14 then determines whether as many address lists as intended for a test have been generated (step S303). When as many address lists as intended for a test have not been generated (No in step S303), the test data generating unit 14 performs processing of step S301.

When as many address lists as intended for a test have not been generated (Yes in step S303), the test data generating unit 14 initializes a region to be accessed, that is, the test region 31 by using test data (step S304). The test data generating unit 14 then copies data of the test region 31 into the expected value region 32 (step S305), and performs processing described below for each address list included in the access address list 30.

That is, the test data generating unit 14 extracts a memory address and an access instruction from the address list (step S306), and determines whether the access instruction is “store” (step S307). When the access instruction is not “store” (No in step S307), the test data generating unit 14 acquires an expected value corresponding to the memory address from the expected value region 32 and stores the acquired expected value in the address list (step S308).

Then, the test data generating unit 14 determines whether the address list is at the bottom of the access address list 30 (step S309). When the address list is not at the bottom (No in step S309), the test data generating unit 14 performs processing of step S306 for the subsequent address list. When the address list is at the bottom of the access address list (Yes in step S309), the test data generating unit 14 ends the process.

Meanwhile, when the address list is “store” (Yes in step S307), the test data generating unit 14 rewrites data of the expected value region 32 corresponding to the memory address, that is, replaces the data with new data (step S310). The test data generating unit 14 then stores the replaced new data, that is, an expected value, in the address list (step S311), and performs processing of step S309.

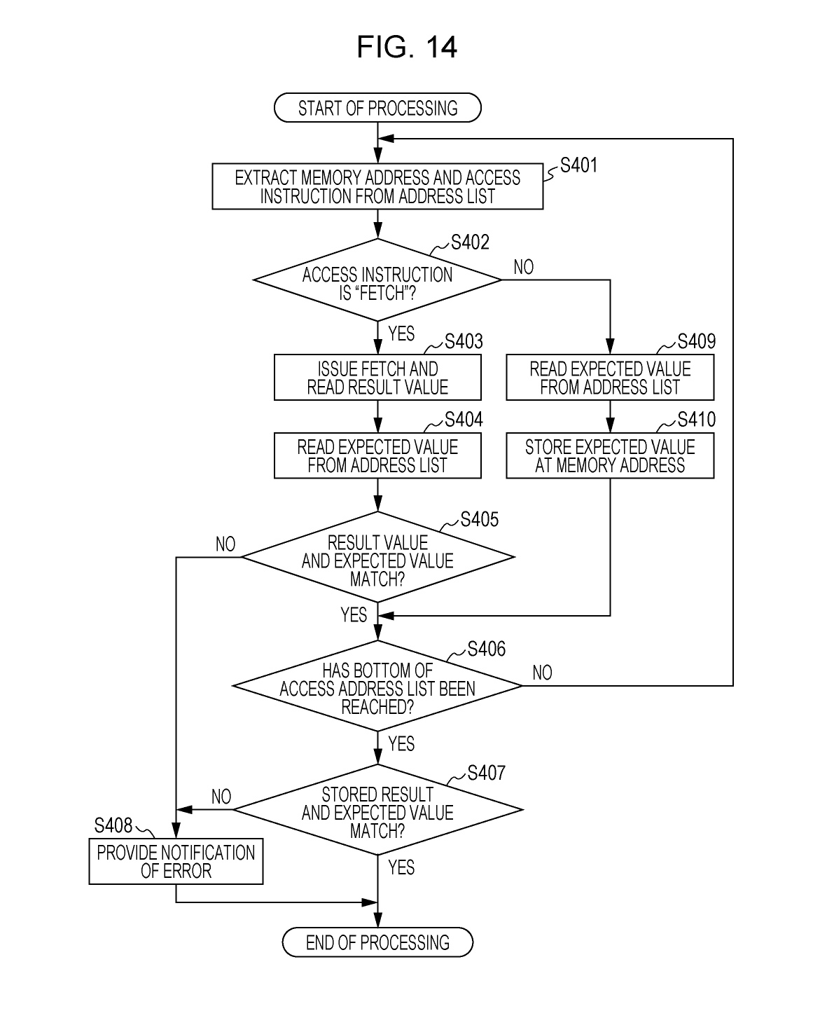

With reference to FIG. 14, an example of a cache test performed by the CPU 21 will be described next. FIG. 14 is a diagram illustrating an example of an operational flowchart for a cache test, according to a first embodiment. Note that the CPU 21 performs processing described below for each address list of the test data 15.

First, the CPU 21 extracts a memory address and an access instruction from an address list (step S401). Then, the CPU 21 determines whether the access instruction is “fetch” (step S402). When the access instruction is “fetch” (Yes in step S402), the CPU 21 issues a “fetch” instruction and then reads data cached as a result of the instruction by the cache memory 23, as a result value (step S403).

Then, the CPU 21 reads an expected value from the address list cached by the cache memory 23 (step S404). The CPU 21 determines whether the result value and the expected value match (step S405). When the result value and the expected value match (Yes in step S405), the CPU 21 determines whether the address list is at the bottom of the access address list 30 (step S406).

Meanwhile, when the access instruction is not “fetch” (No in step S402), the CPU 21 reads an expected value from the address list (step S409) and stores the expected value at the read memory address (step S410).

When it is determined that the address list is at the bottom of the access address list 30 (Yes in step S406), the CPU 21 determines whether the result of storing the expected value in step S410 and the expected value match (step S407). When the result of storing the expected value and the expected value match (Yes in step S407), the CPU 21 ends processing.

Note that if the result of storing the expected value and the expected value do not match (No in step S407), the CPU 21 provides notification of an error (step S408) and then ends processing. Also, when the result value and the expected value do not match (No in step S405), the CPU 21 provides notification of an error (step S408) and then ends processing. Also, when the address list is not at the bottom of the access address list 30 (No in step S406), the CPU 21 performs processing of step S401 for another address list.

### Effects of First Embodiment

As described above, the test data generating program 13 generates a memory address, an access instruction, and an expected value of data that is to be cached by the cache memory 23 when memory access is performed. The test data generating program 13 also generates data to be stored in the test region 31 designated by the memory address.

The test data generating program 13 then generates an address list having a memory address, an access instruction, and an expected value in one cache block. Thereafter, the test data generating program 13 generates the test data 15 in which the address list is arranged so as to be stored in a different cache line from the generated data.

Therefore, when the test data 15 is used when a cache test of the cache memory 23 is carried out, the CPU 21 is able to cause the cache memory 23 to cache the memory address, the access instruction, and the expected value by one memory access. As a result, the test data generating program 13 may improve the efficiency of a cache test.

Note that an example effect is as follows. Using the test data 15, a cache test that causes 80,000 accesses per CPU is carried out. This enables the clock rate during the cache test to be reduced by about 12% compared to the method illustrated in FIG. 1.

Moreover, in the case where a cache test is carried out using the test data 15, when the cache memory 23 caches an expected value, the CPU 21 causes the cache memory 23 to cache the expected value in a different cache line from the data. For this reason, mediation processing due to an unnecessary contention is unnecessary, and therefore the test data generating program 13 may improve the efficiency of a cache test.

Moreover, when the test data generating program 13 causes plural pieces of test data #1 through #3 to be cached in the same cache line included in the cache memory 23 to cause a contention, the test data generating program 13 performs the following processing. That is, at the time of generating the access address list 30, the test data generating program 13 generates memory addresses that allow the cache memory 23 to cache the plural pieces of test data #1 through #3 in the same cache line, and causes the generated memory addresses to be included in address lists.

For this reason, in the case of carrying out a cache test using the test data 15, the CPU 21 causes a contention at the time of caching the test data #1 through #3 and does not cause a contention at the time of caching an expected value. Thus, the test data generating program 13 may test a contention in the same cache line, without reducing the efficiency of a cache test.

Moreover, the test data generating program 13 generates the access address list 30 so that address lists of the access address list 30 are stored in respectively different cache lines. For example, for this reason, in the case of carrying out a cache test using the test data generating program 13, the CPU 21 stores address lists of the access address list 30 in respectively different cache lines. As a result, the test data generating program 13 inhibits a contention of expected values, and therefore may improve the efficiency of a cache test.

The test data generating program 13 stores the same data as test data to be read, as the expected value, in an address list when the access instruction is to read data. The test data generating program 13 also stores data to be written, as the expected value, in an address list when the access instruction is to write data. For this reason, the test data generating program 13 may carry out a cache test either in the case of data reading or in the case of data writing.

### Second Embodiment

Although the embodiment of the present disclosure has been described above, the present disclosure may be carried out in a variety of different forms other than the above embodiment. Accordingly, another embodiment included in the present disclosure will be described hereinafter as a second embodiment.

(1) Test Data

When arranging the test data 15 in the memory 27, the cache test program 28 described above arranges the test data 15 in a storage area designated by the same memory address as the memory address in the memory 12. The embodiment, however, is not limited to this.

For example, the test data generating program 13 generates address lists including memory addresses for storage of the test data #1 through the test data #3 in the memory 27. At this point, the test data generating program 13 generates address lists including memory addresses that allow the cache memory 23 to store the test data #1 through the test data #3 in the same cache line.

The test data generating program 13 also generates such memory addresses that allow storage in a different cache line from the cache line in which the test data #1 through the test data #3 are to be stored. Then, the test data generating program 13 instructs the cache test program 28 to store address lists at the generated memory addresses. As a result, the test data generating program 13 is able to arrange the test data 15 so that expected values and the test data #1 through the test data #3 are cached in different cache lines.

Furthermore, the test data generating program 13 transmits the test data #1 through the test data #3 to the cache test program 28 and instructs the cache test program 28 to store the test data #1 through the test data #3 at the memory addresses included in the address lists. As a result, the cache test program 28 is able to store the test data #1 through the test data #3 in storage areas designated by the memory addresses included in the address lists.

Note that the test data generating program 13 may transmit, to the cache test program 28, memory addresses at which the access address list 30 and the test region 31 included in the test data 15 are to be arranged, in such a manner that the memory addresses are included in the test data 15. In such a case, the cache test program 28 will arrange the access address list 30 and the test region 31 in accordance with the memory addresses included in the test data 15.

(2) Test Information Generating Device 10 and Information Processing Device 20

In the above first embodiment, the description has been given of the example in which the test information generating device 10 for generating the test data 15 and the information processing device 20 are different devices in consideration of the reliability of the information processing device 20, which is the target of a cache test. However, the embodiment is not limited to this. For example, a device to be tested may be configured to generate test data.

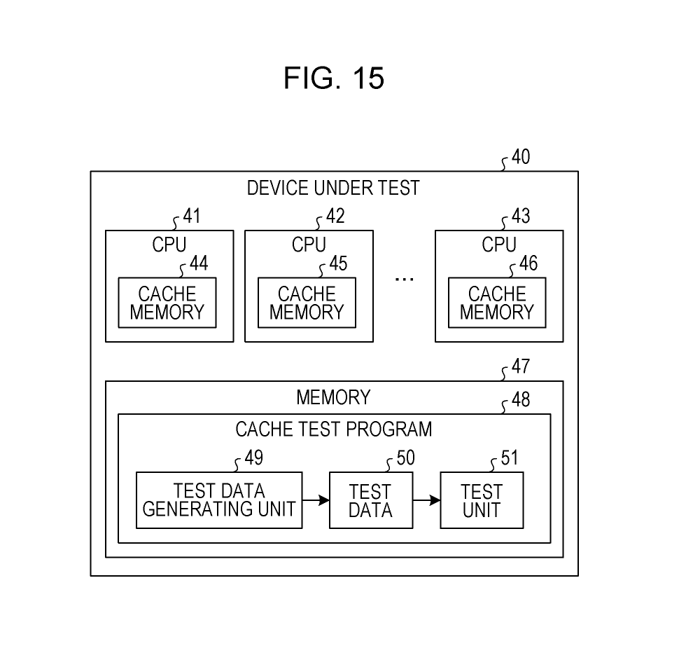

FIG. 15 is a diagram illustrating an example of a cache test program, according to a second embodiment. For example, in the example illustrated in FIG. 15, a device under test 40 includes a plurality of CPUs 41 through 43 and a memory 47. The CPUs 41 through 43 include cache memories 44 through 46, respectively. The memory 47 includes a cache test program 48.

The cache test program 48 includes a test data generating unit 49 that exerts a function similar to that of the test data generating unit 14, test data 50 that is data similar to the test data 15, and a test unit 51 that exerts a function similar to that of the test unit 29. That is, the cache test program 48 generates the test data 50, which is data similar to the test data 15, in the memory 47. Then, the cache test program 48 may carry out a cache test of each of the cache memories 44 through 46 using the generated test data 50.

(3) Miscellaneous

Note that the test data generating program 13 may be implemented in such a way that a program prepared in advance is executed by a computer, such as a personal computer or a workstation. The test data generating program 13 may be distributed over networks, such as the Internet. Moreover, the test data generating program 13 is recorded on a computer readable recording medium such as a hard disk, flexible disk (FD), compact disc read only memory (CD-ROM), magneto optical disc (MO), or digital versatile disc (DVD). Moreover, the test data generating program 13 may also be executed by a computer that reads the test data generating program 13 from a recording medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A test-data generating method performed by a test-data generating device for generating test data for a cache memory that caches data in a cache line in accordance with a memory address, the test-data generating method comprising:
generating a first memory address to be accessed, first data to be arranged in a storage area designated by the first memory address, an access instruction for the first memory address, and an expected value of the first data that is to be cached in the cache memory when memory access is performed in accordance with the access instruction;
generating an address list including the first memory address, the access instruction, and the expected value, so that the address list is stored in a cache block that is cacheable in the cache memory by one memory access; and
generating test data in which the address list and the first data are arranged so that the address list is cached in a different cache line from the first data.

2. The test-data generating method of claim 1, wherein
when plural pieces of the first data is to be cached in the cache memory, the first memory addresses identifying storage areas for storing the plural pieces of the first data are generated so that the cache memory caches the plural pieces of the first data in one cache line.

3. The test-data generating method of claim 1, wherein
when a plurality of the address lists are to be cached in the cache memory, the plurality of the address lists are arranged in the test data so that the cache memory caches the plurality of the address lists in respectively different cache lines.

4. The test-data generating method of claim 1, wherein
the first data is set as the expected value when the access instruction is to read data; and
second data to be written to a storage area designated by the first memory address is set as the expected value when the access instruction is to write data.

5. The test-data generating method of claim 1, wherein
the test data defines a second memory address for arranging the address list so that the address list is stored in a different cache line from the first data.

6. A method for testing a cache memory that caches data in a cache line in accordance with a memory address, the method being performed by an apparatus including the cache memory, the method comprising:
arranging first data to be cached in the cache memory, in a storage area designated by a memory address;
generating an address list including the memory address, an access instruction for the memory address, and an expected value of the first data that is to be cached in the cache memory when memory access is performed in accordance with the access instruction, so that the address list is contained in a cache block that is cacheable in the cache memory by one memory access;
arranging the generated address list in the memory so that the address list is cached in a different cache line from the first data;
after caching the address list in the cache memory, performing memory access in accordance with the memory address and the access instruction included in the address list cashed in the cache memory so that the first data is cached in the cache memory; and
determining whether the first data cached in the cache memory and the expected value included in the address list cashed in the cache memory match.

7. The method of claim 6, wherein
when plural pieces of the first data is to be cached in the cache memory, the memory addresses identifying storage areas for storing the plural pieces of the first data are generated so that the cache memory caches the plural pieces of the first data in one cache line.

8. The method of claim 6, wherein
when a plurality of the address lists are to be cached in the cache memory, the plurality of the address lists are arranged in the memory so that the cache memory caches the plurality of the address lists in respectively different cache lines.

9. The method of claim 6, wherein
the first data is set as the expected value when the access instruction is to read data; and
second data to be written to a storage area designated by the memory address is set as the expected value when the access instruction is to write data.

10. A test-data generating device for generating test data for a cache memory that caches data in a cache line in accordance with a memory address, the test data generating device comprising:
a processor configured:
to generate first data to be stored in a storage area designated by a first memory address,
to generate an address list including the first memory address to be accessed, an access instruction for the first memory address, and an expected value of the first data that is to be cached in the cache memory when memory access is performed in accordance with the access instruction, so that the address list is stored in a cache block that is cacheable in the cache memory by one memory access, and
to generate the test data in which the address list and the first data are arranged so that the address list is cached in a different cache line from the first data; and
a memory configured to store the test data.

11. The test-data generating device of claim 10, wherein
when plural pieces of the first data is to be cached in the cache memory, the first memory addresses identifying storage areas for storing the plural pieces of the first data are generated so that the cache memory caches the plural pieces of the first data in one cache line.

12. The test data generating device of claim 10, wherein
when a plurality of the address lists are to be cached in the cache memory, the plurality of the address lists are arranged in the test data so that the cache memory caches the plurality of the address lists in respectively different cache lines.

13. The test-data generating device of claim 10, wherein
the first data is set as the expected value when the access instruction is to read data; and
second data to be written to a storage area designated by the first memory address is set as the expected value when the access instruction is to write data.

14. The test-data generating device of claim 10, wherein
the test data defines a second memory address for arranging the address list so that the address list is stored in a different cache line from the first data.

15. A computer readable recording medium having stored therein a program causing a computer to execute a process for generating test data for a cache memory that caches data in a cache line in accordance with a memory address, the process comprising:
generating a memory address to be accessed, first data to be stored in a storage area designated by the memory address, an access instruction for the memory address, and an expected value of the first data that is to be cached in the cache memory when memory access is performed in accordance with the access instruction;
generating an address list including the memory address, the access instruction, and the expected value so that the address list is stored in a cache block that is cacheable in the cache memory by one memory access; and
generating the test data in which the address list and the data are arranged so that the address list is cached in a different cache line from the first data.

16. The computer readable recording medium of claim 15, wherein
when plural pieces of the first data is to be cached in the cache memory, the first memory addresses identifying storage areas for storing the plural pieces of the first data are generated so that the cache memory caches the plural pieces of the first data in one cache line.

17. The computer readable recording medium of claim 15, wherein
when a plurality of the address lists are to be cached in the cache memory, the plurality of the address lists are arranged in the test data so that the cache memory caches the plurality of the address lists in respectively different cache lines.

18. The computer readable recording medium of claim 15, wherein
the first data is set as the expected value when the access instruction is to read data; and
second data to be written to a storage area designated by the first memory address is set as the expected value when the access instruction is to write data.

19. The computer readable recording medium of claim 15, wherein
the test data defines a second memory address for arranging the address list so that the address list is stored in a different cache line from the first data.

20. A computer readable recording medium having stored therein a program causing a computer to execute a process for testing a cache memory that caches data in a cache line in accordance with a memory address, the process comprising:
arranging data to be cached in the cache memory, in a storage area designated by a memory address;
generating an address list including the memory address, an access instruction for the memory address, and an expected value of the data that is to be cached in the cache memory when memory access is performed in accordance with the access instruction, so that the address list is contained in a cache block that is cacheable in the cache memory by one memory access;
arranging the generated address list in the memory so that the address list is cached in a different cache line from the data;
after caching the address list in the cache memory, performing memory access in accordance with the memory address and the access instruction included in the address list cashed in the cache memory so that the data is cached in the cache memory; and
determining whether the data cached in the cache memory and the expected value included in the address list cashed in the cache memory match.
